(19) United States
(12) Patent Application Publication
(10) Pub. No.: US 2015/0071119 A1
(43) Pub. Date: Mar. 12, 2015

(54) Technique for Explicit Path Control

(71) Applicant: Telefonaktiebolaget L M Ericsson (publ), Stockholm (SE)

(72) Inventors: János Farkas, Kecskemet (HU); David Ian Allan, San Jose, CA (US); Panagiotis Saltsidis, Stockholm (SE)

(21) Appl. No.: 14/385,619

(22) PCT Filed: Jan. 14, 2014
(86) PCT No.: PCT/EP2014/050576

§ 371 Date: Sep. 16, 2014

Related U.S. Application Data
(60) Provisional application No. 61/752,164, filed on Jan. 14, 2013.

(51) Int. Cl. H04L 12/751

(52) U.S. Cl. CPC H04L 45/02
USPC 370/255

(57) ABSTRACT

A technique for explicit path control for traffic forwarding in a network comprising multiple nodes is described. A device embodiment comprises a path computation element that is configured to receive, from an edge node, control protocol data units of a control protocol. The path computation element is further configured to determine an explicit path from information contained in the received control protocol data units and to instruct the edge nodes to perform an action to have the explicit path installed in the network.

### TECHNICAL FIELD

The present disclosure generally relates to traffic forwarding in a network comprising multiple network nodes. In particular, a technique for explicit path control in connection with traffic forwarding is described. The technique can be practiced in the form of devices, nodes, methods and computer program products.

### BACKGROUND

Certain network scenarios, traffic types, etc. require the ability to explicitly control the forwarding path packets and other data units take in the network. Additionally, reservation of network resources is required for some traffic types (e.g., due to quality demands).

The forwarding paths within a network are typically controlled automatically by a path control protocol. For example, a spanning tree protocol was traditionally used for path control in Ethernet networks. Link state control protocols such as the Intermediate System to Intermediate System (IS-IS) or the Open Shortest Path First (OSPF) routing protocols are used for path control in Internet Protocol (IP) networks. Link state control is also available for Ethernet networks today. It is provided by Shortest Path Bridging (SPB), which is an extension to IS-IS.

These protocols typically provide a default path, which is the shortest path or a spanning tree. Deviation from the default path and implementing explicit paths in the network is very difficult. While the operation of the protocols could be influenced by cost parameters, the costs required for different explicit paths may contradict each other. Aside from the distributed protocols available today, only management controls are available for setting up an explicit path in Ethernet networks.

The Multiple Stream Reservation Protocol (MSRP) is able to perform reservation on top of a spanning tree in an Ethernet network. OSPF or IS-IS is used in order to provide the default path in case of Multiprotocol Label Switching (MPLS) networks, too. The Resource reSerVation Protocol (RSVP) with Traffic Engineering (TE) extensions (RSVP-TE) can be used on top for the establishment of an explicit route and for reservation in MPLS.

Network operators prefer to have a tool, such as a protocol, aiding achieving their goals instead of manual configuration at each network device, which holds for path control, too. Currently, there is no protocol that could efficiently provide explicit path control in Ethernet networks. As said, configuring each node along the path by means of management controls is in many cases not viable, especially in a large network. The application of RSVP-TE in Ethernet is often not viable either; it is over-shooting and has a huge implementation burden, not to mention that Layer 3 (L3) solutions are not applicable in Ethernet networks due to being bound to IP. Furthermore, in certain network scenarios, running of a signaling protocol (e.g., MSRP or RSVP-TE) is not desired. Still further, MSRP is not applicable for explicit path control, it is even not the task of MSRP, which is run on top of already established paths.

### SUMMARY

There is a need for efficiently performing explicit path control in a network comprising multiple network nodes.

According to one aspect, a device for explicit path control for traffic forwarding in a network comprising multiple nodes is presented. The device is adapted to be connected to an edge node of the network and comprises a path computation element (PCE). The PCE is configured to receive, from the edge node, control protocol data units (PDUs) of a control protocol. The PCE is further configured to determine an explicit path from information contained in or derived from the received control PDUs, and to instruct the edge node to perform an action to have the explicit path installed in the network.

The device is in one variant an external device. As an example, the device may be external to the network domain to which the edge node belongs. As such, in some variants, one or more nodes within the network domain may not be aware of the device (e.g., a network typology maintained by such one or more nodes may not include the device).

The control PDUs may be compliant with a control protocol used for traffic forwarding, or routing, in the network (e.g., IS-IS or OSPF). Alternatively, or additionally, the control PDUs may be compliant with a control protocol used for resource reservation in the network (e.g., MSRP).

The PCE may determine the explicit path in different manners, for example based on calculations or computations. The explicit path may take the form of a (e.g., essentially linear) route or may comprise one or more branches (e.g., in the form of a tree). The explicit path may be a point-to-point path, a point-to-multipoint path or a multipoint-to-multipoint path.

The explicit path may be defined in the form of an ordered or unordered list of node identifiers and/or interface identifiers. As such, interface identifiers (e.g., port IDs) of the network nodes may in certain implementations be used in addition to their node identifiers (e.g., system ID, bridge ID, or MAC or IP address).

As for explicit path installation, the PCE may instruct the edge node in various ways. As an example, instructing the edge node may comprise informing the edge node of the explicit path determined by the PCE.

The device may further comprise one or more databases. Such one or more databases may be maintained by the PCE on the basis of the control PDUs received from the edge node. In one example, the control PDUs are link state PDUs (LSPs). In such a case the database may be a replica of a link state database (LSDB) maintained by nodes in the network. Of course, the control PDUs may also be any PDUs different from LSPs, and the nature of the corresponding database will change in a similar manner.

The PCE may be configured to determine the explicit path from information contained in the database maintained on the basis of the control PDUs. To this end, the PCE may have access to the database.

As indicated above, the PCE may instruct the edge node in various ways. As an example, the PCE may be configured to instruct the edge node by means of a control PDU initiated by the PCE. The PCE may further be configured to include a descriptor of the explicit path in the control PDU. The descriptor may comprise type, length and value (TLF) fields. The descriptor may further comprise an attribute of a network resource to be reserved. As an example, the attribute may be indicative of a bandwidth requirement.

It should be noted that in certain situations, the PCE may only determine reservation information from the information contained in the received control PDUs (e.g., no explicit path would be determined in such situations). The PCE will then instruct the edge node to perform an action to have the reservation information distributed in the network. Those steps may be performed independently from (e.g., before or after) having the explicit path installed in the network.

According to a further aspect, an edge node for explicit path control for traffic forwarding in a network comprising multiple nodes is presented. The edge node is configured to be connected to a device (e.g., the device discussed hereinabove). The edge node is further configured to receive, from the device, an instruction to have an explicit path installed in the network. The edge node is also configured to send, to the other network nodes, a control PDU of a control protocol for instructing the other networks to install the explicit path.

The edge node may be configured to receive the instruction from the device in a control PDU of the control protocol. Various examples of such a control protocol have been discussed above and will be discussed hereinafter.

The instruction received from the device by the edge node may include a descriptor of the explicit path. The control PDU sent by the edge node, the control PDU received from the device, or both, may carry the descriptor of the explicit path. In certain situations, the descriptor may further comprise an attribute of a network resource to be reserved. In other situations, the edge node may receive reservation information instead of explicit path information from the device. In such situations only the reservation information may be distributed by the edge node in the control PDU sent to the other network nodes. According to the present disclosure, the control PDU may be one of an LSP, OSPF, PDU, MSRPDU or any other control protocol PDU.

Also provided is a node for explicit path control for traffic forwarding in a network comprising multiple nodes. The node is configured to receive control PDUs of a control protocol and comprises a PCE. The PCE is configured to determine an explicit path from information contained in or derived from the received control PDUs, and to perform an action to make the other network nodes install the explicit path.

The PCE of the node may have a configuration that is at least in part similar to the configuration of the PCE of the device presented herein. The node comprising the PCE may be configured as an edge node of the network. In other scenarios, the node may be configured as network core node.

The node may further comprise a database of the control protocol. The database may be maintained on the basis of control PDUs received by the node under the control protocol. Moreover, the PCE may have access to the database for determination of the explicit path. In case the control PDUs are LSPs, the database may an LSDB.

The action to make the other network nodes install the explicit path may include one or more steps, such as instructing a local instance of a control protocol application to propagate the explicit path. The local instance of the control protocol may be installed together with the PCE on the node.

In all the scenarios discussed herein, the PCE may be configured as an application running on the device or node, and the PCE application may be configured to instruct a control protocol application instance. The control protocol application instance may be local or remote from the perspective of the PCE application.

Generally, the explicit path may be determined in various forms. As an example, the explicit path may be determined in the form of a list of node identifiers. This list may be ordered. Alternatively, or in addition, the explicit path may be determined in the form of branching points of a tree.

According to the present disclosure, one or more control protocols may be used in the network. The one or more control protocols may comprise at least one of a path control protocol and a reservation control protocol. As an example, the control protocol may be one of the IS-IS protocol, an extension thereof, the OSPF protocol, an extension thereof, the MSRP, an enhancement thereof, and a combination of the IS-Is protocol and MSRP or its extensions and enhancements.

Any of the apparatuses described herein may further comprise a database configured to store explicit paths. Such a database may be maintained by all or a subset of the nodes within the network.

Also provided is a method for explicit path control for traffic forwarding in a network comprising multiple nodes. The method comprises receiving, from an edge node of the network, control PDUs of a control protocol, determining an explicit path from information contained in or derived from the received control PDUs, and instructing the edge node to perform an action to have explicit path installed in the network.

According to a further aspect, a method for explicit path control for traffic forwarding in a network comprising multiple nodes is presented, wherein the method comprises the following steps performed by a node of a network: receiving an instruction to have an explicit path installed in the network, and sending, to the other network nodes, a control PDU of a control protocol of instructing the other network nodes to install the explicit path.

According to a still further aspect, a method for explicit path control for traffic forwarding in a network comprising multiple nodes is presented, wherein the method comprises the following steps performed by a node of the network: receiving control PDUs of a control protocol, determining an explicit path from information contained in or derived from the received control PDUs, and performing an action to make the other network nodes to install the explicit path.

The method may further comprise maintaining a database that stores explicit paths. The database may be maintained locally by a device or node performing the above methods, or remotely by any network node configured to install an explicit path. As such, installing the explicit path may include storing the explicit path in the database.

The database that stores explicit paths may be maintained by a device or node separately from a link state database and/or a traffic engineering database. Moreover, in the database that stores explicit paths, the paths may only be stored by network nodes that take part in those paths. As an example, a node within the network may store only those explicit paths to which it belongs.

In all the method aspects presented herein, determining an explicit path may comprise selectively calculating the explicit path in case no existing path meets prevailing needs. In other words, in situations in which an existing path meets the prevailing needs, the step of determining an explicit path may be omitted. In such a case, signaling of the explicit path may be replaced by signaling the existing path that needs the prevailing needs and/or an identifier corresponding to that path, e.g., a Virtual Local Area Network identifier (VLAN ID).

Also provided is a computer program product comprising program code portions for performing the steps of any of the claims presented herein when the computer program product is run on a computing device. The computer program product may be stored on a computer-readable recording medium, such as a CD-ROM, DVD or semiconductor memory. The computer program product may also be provided for download via a communication network.

### BRIEF DESCRIPTION OF THE DRAWINGS

Further aspects, details and advantages of the present disclosure will become apparent from the following description of exemplary embodiments in conjunction with the accompanying drawings, wherein:

FIG. 1 illustrates a network domain in which embodiments of the present disclosure can be implemented;

FIG. 2 illustrates network paths in the network domain of FIG. 1;

FIG. 3 shows a network embodiment with path control external to the network domain,

FIG. 4 shows a network embodiment with path control installed in network nodes;

FIG. 5 shows an embodiment of an explicit path, or explicit route, descriptor;

FIG. 6 shows an apparatus embodiment with an external PCE;

FIG. 7 shows an apparatus embodiment with a PCE installed on a node;

FIG. 8 shows an embodiment of one or more databases;

FIG. 9A show flow diagrams of method embodiments for explicit to 9C path control;

FIG. 10 shows a flow diagram of a method embodiment for reservation; and

FIG. 11 shows an embodiment of a Layer 2 network scenario.

### DETAILED DESCRIPTION

In the following description of exemplary embodiments, for purposes of explanation and not limitation, specific details are set forth, such as particular methods, functions and procedures, in order to provide a thorough understanding of the technique presented herein. It will be apparent to one skilled in the art that this technique may be practiced in other embodiments that depart from these specific details. For example, while the following embodiments will be described with respect to exemplary routing, or forwarding, protocols and exemplary reservation protocols, it will be appreciated that the present disclosure could also be implemented in connection with additional or alternative control protocols.

Moreover, those skilled in the art will appreciate that the methods, functions and procedures explained herein may be implemented using software functioning in conjunction with a programmed microprocessor, an application specific integrated circuit (ASIC), a digital signal processor (DSP) or a general purpose computer. It will also be appreciated that while the following embodiments will primarily be described in the context of methods, nodes and devices, the present disclosure may also be embodied in a computer program product which can be loaded to run on a computing device or distributed computer system that comprises one or more processors and one or more memories, wherein the one or more memories are configured to store one or more programs that perform the methods, functions and procedures disclosed herein.

The embodiments presented herein provide a technique (e.g., methods and apparatuses) for the control of forwarding paths in packet networks and, optionally, for performing reservations on top of the packet forwarding paths. Network operators generally prefer to have a tool, such as a protocol, aiding achieving their goals instead of manual configuration at each device, which holds for path control, too. In order to keep it simpler, it is even better if the goals can be met by a single protocol, especially if it is just an extension to an already used one. Therefore, a solution integrating explicit path control and, optionally, reservation into a protocol is desirable. It is even better if the base protocol is already used for the establishment of the forwarding paths. Having a single protocol controlling both the default and the explicit paths is attractive in IP networks, too. A solution integrated into a single protocol does not exist for IP/MPLS networks either.

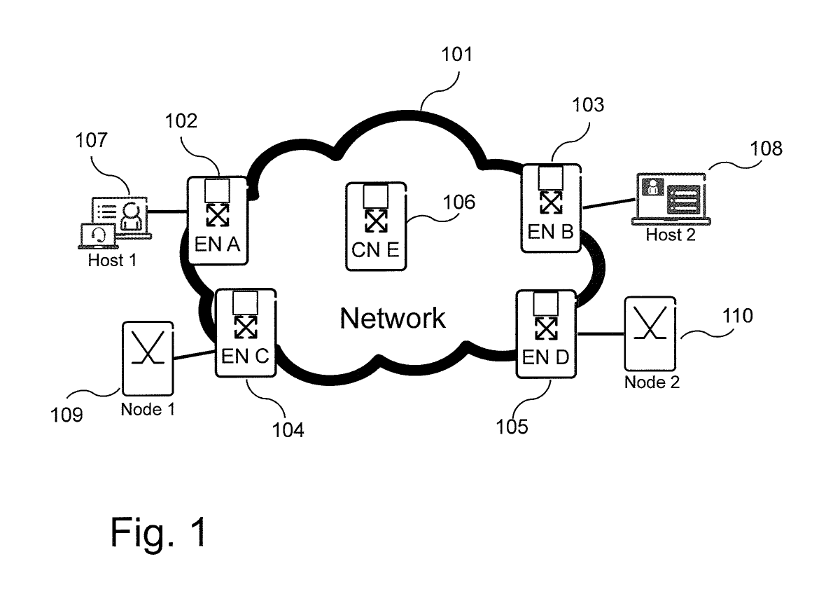

An exemplary packet network 101 of the type in which embodiments of the present disclosure can be implemented is illustrated in FIG. 1. The network nodes in the packet network 101 fall into two categories: they either are Edge Nodes (EN), such as nodes 102, 103, 104, and 105, or they are Core Nodes (CN), such as node 106.

A packet network typically connects hosts to each other, e.g., Host 1 (107) and Host 2 (108) in FIG. 1. A packet network is often used to connect further network devices, such as further network nodes, e.g., Node 1 (109) and Node 2 (110) in FIG. 1. A network domain such as the one of FIG. 1 is often controlled by an Interior Gateway Protocol (IGP) such as the Intermediate System to Intermediate System (IS-IS) or the Open Shortest Path First (OSPF) link state routing protocol.

A packet network such as network 101 typically either applies Layer 2 or Layer 3 mechanisms as the main principle for packet forwarding. That is, forwarding may be based on Layer 2 addresses, i.e., Medium Access Control (MAC) addresses, or based on IP addresses in case of Layer 3 forwarding. Packets are often referred to as frames in case of Layer 2.

The basic path control mechanism applied in packet networks is shortest path routing. Both IS-IS and OSPF routing protocols implement the Dijkstra algorithm for path computation, which is often referred to as the Shortest Path First (SPF) algorithm because it selects the shortest path from the possible paths between the source and the destination of the packet. The core of link state routing is that each network node maintains an identical replica of the Link State Database (LSDB), which is comprised of the link state information the nodes flood to each other. The LSDB for example provides the network topology, which is the input for the Dijkstra algorithm.

Constrained Based Routing (CBR) was introduced in order to be able to deviate somewhat from the shortest path. Different parameters have been introduced to be associated with network links, e.g., color, available bandwidth, or link delay, which are flooded together with the other link state data during the link state operation. Network nodes thus are able to maintain a database comprising these further characteristic of network components, which database is referred to as Traffic Engineering Database (TED). In case of CBR, the SPF algorithm is run on a pruned topology that is only comprised of links meeting a constraint. Thus, in fact a Constrained Shortest Path First (CSPF) algorithm is applied which produces a Constrained Shortest (CS) path.

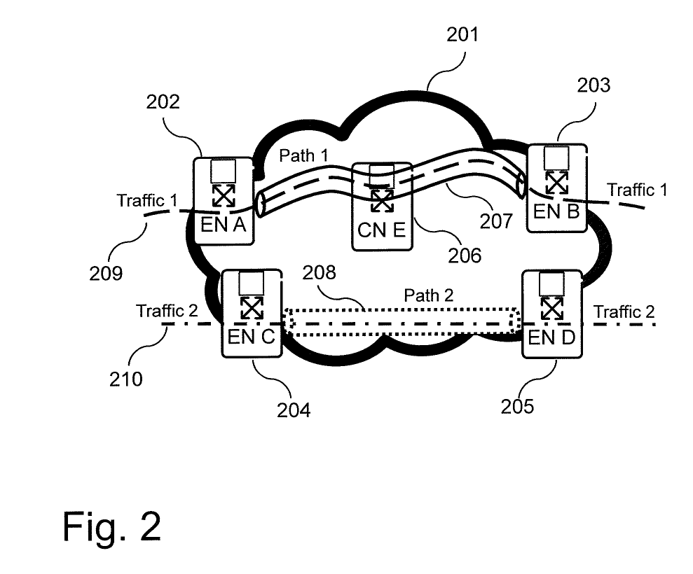

However, there might be certain traffic types, network conditions or operator preferences for which neither the shortest paths nor CS paths are satisfactory. In order to be able to meet those needs the network has to be able to provide explicit routes as well. FIG. 2 illustrates explicit routing compared to shortest path routing in a network 201.

In FIG. 2, Path 2 (208) provides the shortest path between EN C 204 and EN D 205. As the shortest path is just fine for Traffic 2 (210), it is mapped to Path 2 (208). Traffic 1 (209) is between EN A 202 and EN B 203. However, for some reason, Traffic 1 (209) should follow a path (Path 1) completely different from the shortest path (Path 2). In fact, Traffic 1 (209) should be sent through CN E 206, which is not on the shortest path (Path 2) between EN A 202 and EN B 203. Therefore, the network 201 somehow has to install and provide an explicit path, i.e., Path 1 (207), for the packets of Traffic 1 (209).

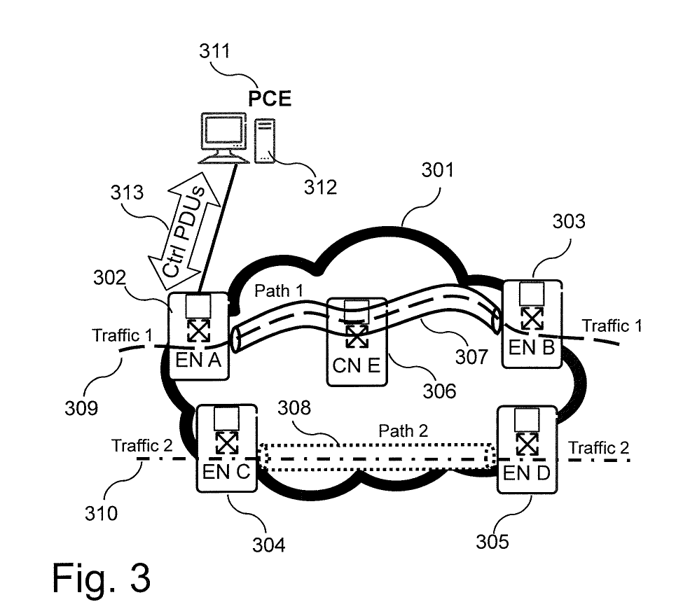

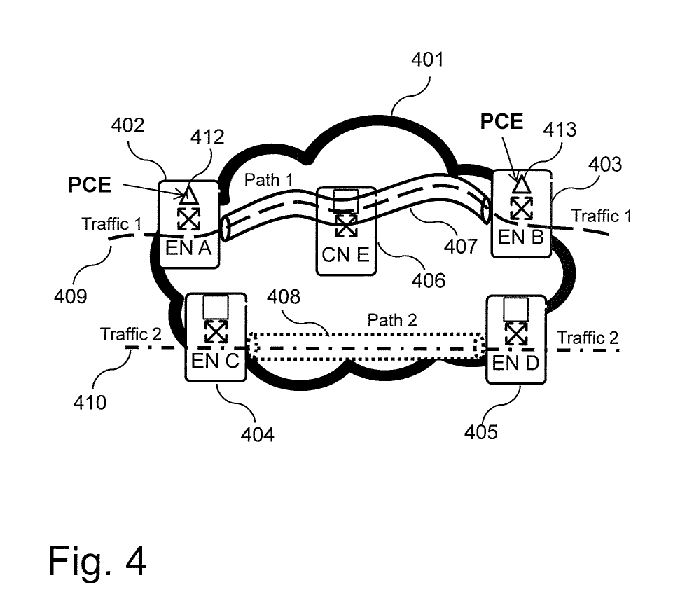

Several network embodiments that are based on the scenario of FIG. 2 are now described in more detail with reference to FIGS. 3 and 4.

The technique proposed herein relies on a Path Computation Element (PCE) application 311, which may be run on a device 312 (e.g., a computer) that is external to the network domain 301, as illustrated in FIG. 3. The external device 312 running the PCE application 311 is connected to one of the ENs of the network, e.g., EN A 302 in the example shown in FIG. 3. Furthermore, the PCE application 311 receives the control PDUs 313 used by the protocols applied for routing and reservation. Therefore, the PCE 311 is able to maintain exactly the same databases as maintained in the network nodes (e.g., 303-306) by the control protocols applied in the network 301. In addition, the PCE 311 can instruct the network nodes 303-306 to perform certain actions, especially the EN A 302 it is connected to, e.g., by means of control PDUs 313 initiated by the PCE 311. Furthermore, the PCE 311 may influence the operation of network control protocols, e.g., by means of the control PDUs 313. Thus, it is the PCE 311 that determines for example Path 1 (307) required for Traffic 1 (309). The PCE 311 then instructs EN A 302 to perform the appropriate actions in order to have the explicit route, i.e., Path 1 (307) installed in the network. For example EN A 302 may send control PDUs 313 to the other network nodes instructing them on installing the explicit route (Path 1). Traffic 2 (310) on the other hand may be routed via Path 2 (308). Note that there may be a single central external PCE 311 applied for a network domain 301 or there may be multiple PCE applications 311 running, e.g., on distinct devices external to the network.

Alternatively, an embodiment may be implemented such that network nodes, e.g., edge nodes, run the PCE application. In this regard, FIG. 4 illustrates the case when a PCE application is run by network nodes instead of external entities as discussed above with reference to FIG. 3.

In the example shown in FIG. 4, EN A 402 and EN B 403 run the PCE application, thus aside performing regular network operation actions both nodes are able to perform the same actions as the external device 312 of FIG. 3. The PCE application is illustrated by a small triangle in the network nodes. That is, 412 is the PCE application run by EN A 402, and 413 is the PCE application run by EN B 403. In the scenario of FIG. 4, Traffic 1 (409) is routed along Path 1 (407) from EN A 402 via CN E 406 to EN B 403. Traffic 2 (410) is routed along Path 2 (408) from EN C 404 to EN D 405.

The PCE application run on the network nodes has access to the databases of the control protocols and can perform such actions that the network node sends out the control PDUs required by the PCE. Thus the PCE application is able to perform the computation of the explicit routes. Furthermore, the PCE application is able to perform the actions required to make further network nodes installing the explicit path, e.g., by means of the hosting node sending out appropriate control PDUs. Network nodes not hosting a PCE application cannot perform explicit path control actions aside installing the path they are instructed to do so and, hence, they do not see any difference between external and network node hosted PCE applications.

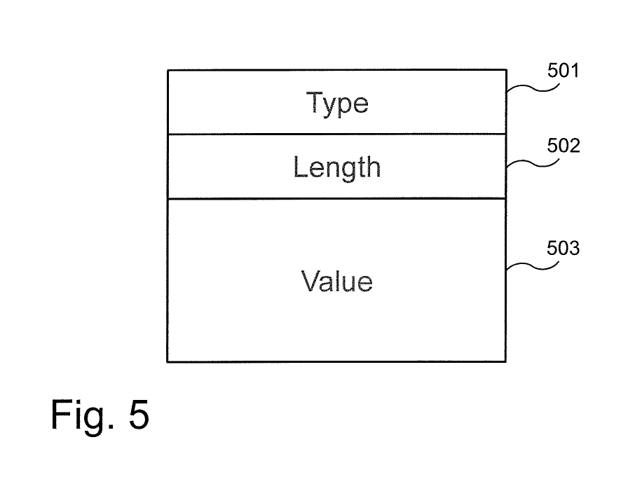

Information pertaining to explicit routes may be signaled, or communicated, in various ways among the network nodes illustrated in FIGS. 3 and 4. As an example, a descriptor as illustrated in FIG. 5 may be used. The descriptor comprises Type 501, Length 502 and Value 503 (TLV) fields. Exemplary realizations of such a descriptor will be described in more detail below.

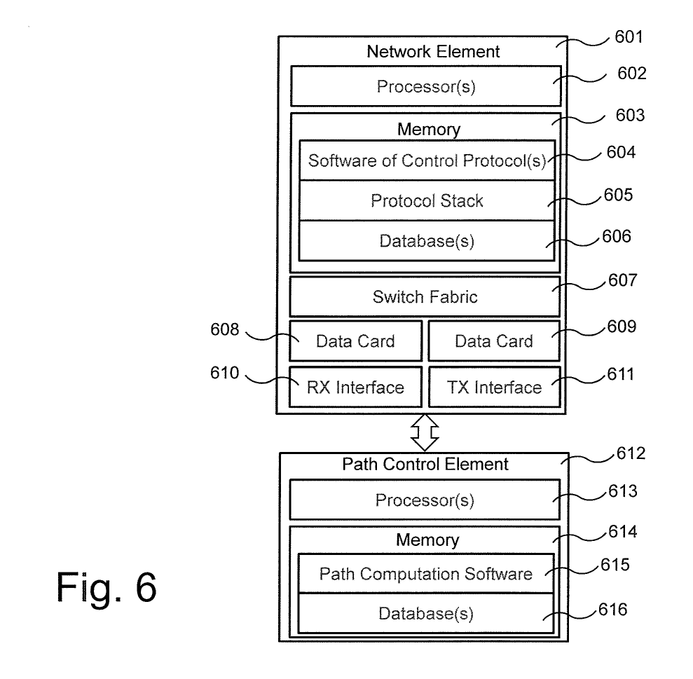

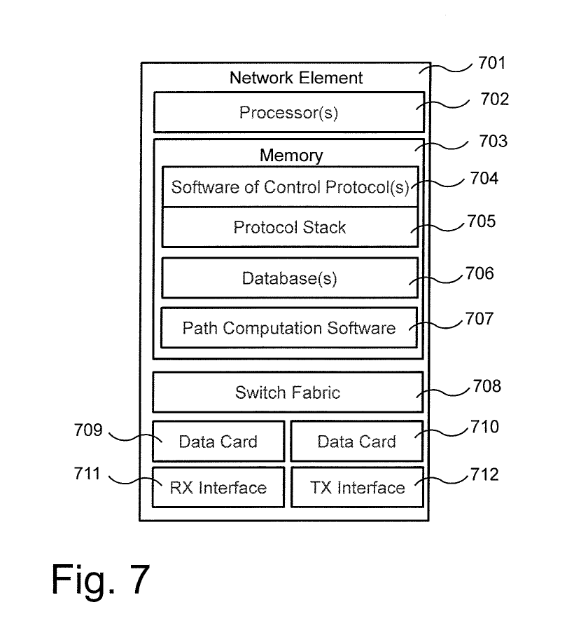

Having the options for the location of the PCE application, there are also two options for an apparatus implementing proposed method embodiments. An apparatus for external PCE is shown in FIG. 6. An apparatus in case of network nodes implementing the PCE application is shown in FIG. 7.

As FIG. 6 shows, there is communication between the network element 601 and the PCE 612 if PCE is hosted by an external device (see FIG. 3). The network element 601 example illustrated in FIG. 6 includes a data plane including a switching fabric 607, a number of data cards, e.g., 608 and 609, at least a receiver (Rx) interface 610 and at least a transmitter (Tx) interface 611. The Rx and Tx interfaces 610 and 611 interface with links on the network, the data cards 608 and 609 perform functions on data received over the interfaces 610 and 611, and the switching fabric 607 switches data between the data cards/I/O cards.

The network element 601 further includes a control plane, which includes one or more processors 602 containing control logic configured to implement, e.g., a link state routing process for controlling shortest path based forwarding. Other processes may be implemented in the control logic as well.

The network element 601 also includes a memory 603, which stores software for control protocols 604, a protocol stack 605, and one or more databases 606. The software for control protocols 604 may contain data and instructions associated with the link state routing process. The protocol stack 605 stores network protocols implemented by the network element 601. The databases 606 are used for determining and storing the forwarding paths. The network element 601 may contain other software, processes, and stores of information to enable it to perform the functions for the proposed Path Control and Reservation (PCR) method and to perform other functions commonly implemented in a network element on a communication network.

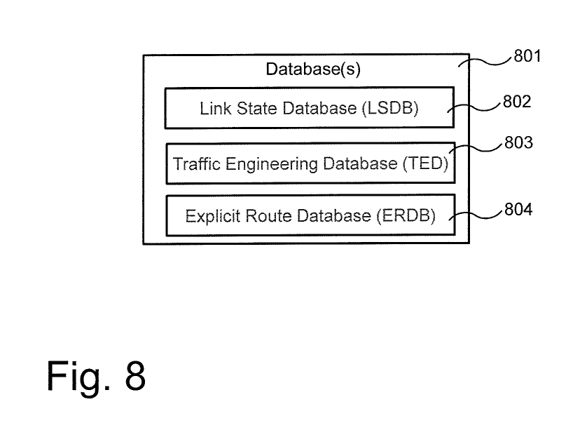

The PCE 612 coupled to the network element 601 includes one or more processors 613 coupled to a memory 614. The processors 613 include logic to perform path computation operations and operations for the instruction of the network element 601. The memory 614 includes path computation software 615 applicable for determining explicit routes and reservation data. The memory 614 also includes databases 616. The databases may include a replica of the databases stored by the network element 601 and may include further databases, e.g., for path computation (see, e.g., FIG. 8).

As FIG. 7 shows, a network element 701 may host PCE software 707 as well (see FIG. 4). Thus the network element 701 example illustrated in FIG. 7 includes a data plane including a switching fabric 708, a number of data cards, e.g., 709 and 710, at least a receiver (Rx) interface 711 and at least a transmitter (Tx) interface 712). The Rx and Tx interfaces 711 and 712 interface with links on the network, the data cards 709 and 710 perform functions on data received over the interfaces 711 and 712, and the switching fabric 708 switches data between the data cards/I/O cards.

The network element 701 also includes a control plane, which includes one or more processors 702 containing control logic configured to implement, e.g., a link state routing process for controlling shortest path based forwarding. Furthermore, the processors 702 also implement the logic for path computation and reservation. Other processes may be implemented in the control logic as well.

The network element 701 also includes a memory 703, which stores software for control protocols 704, a protocol stack 705, one or more databases 707 and the path computation software 706. The software for control protocols 704 may contain data and instructions associated with the link state routing process. The protocol stack 705 stores network protocols implemented by the network element 701. The databases 706 are used for determining and storing the forwarding paths (see, e.g., FIG. 8). The databases 706 are further used by the path computation logic and may involve components required for path computation and reservation. The memory 703 includes path computation software 707 applicable for determining explicit routes and reservation data. The network element 701 may contain other software, processes, and stores of information to enable it to perform the functions for the proposed path control and reservation method and to perform other functions commonly implemented in a network element on a communication network.

FIG. 8 shows an exemplary database 801 that could be maintained by the apparatus of FIG. 6 and/or the apparatus of FIG. 7. As shown in FIG. 8, the database 801 comprises an Explicit Route Database (ERDB) and, optionally, one or more of a Link State Database (LSDB) and a Traffic Engineering Database (TED) 803. Details of the database 801 will be described below.

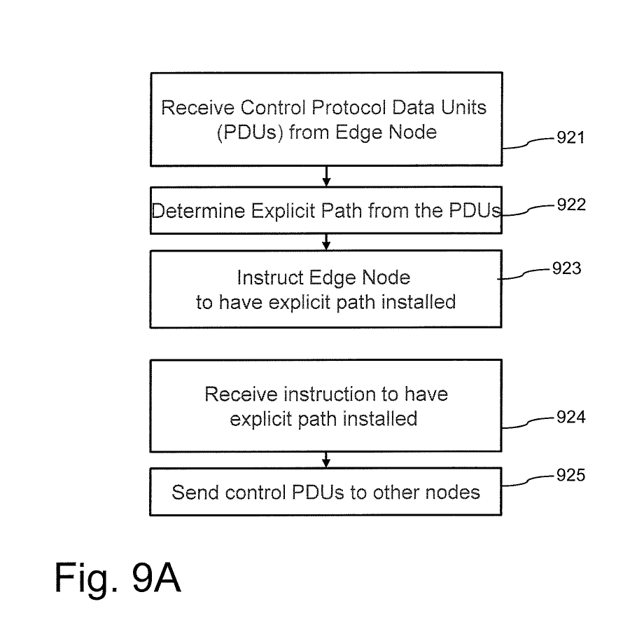

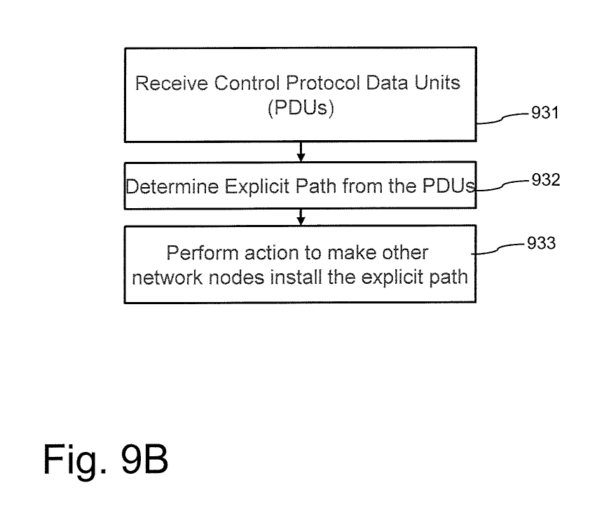

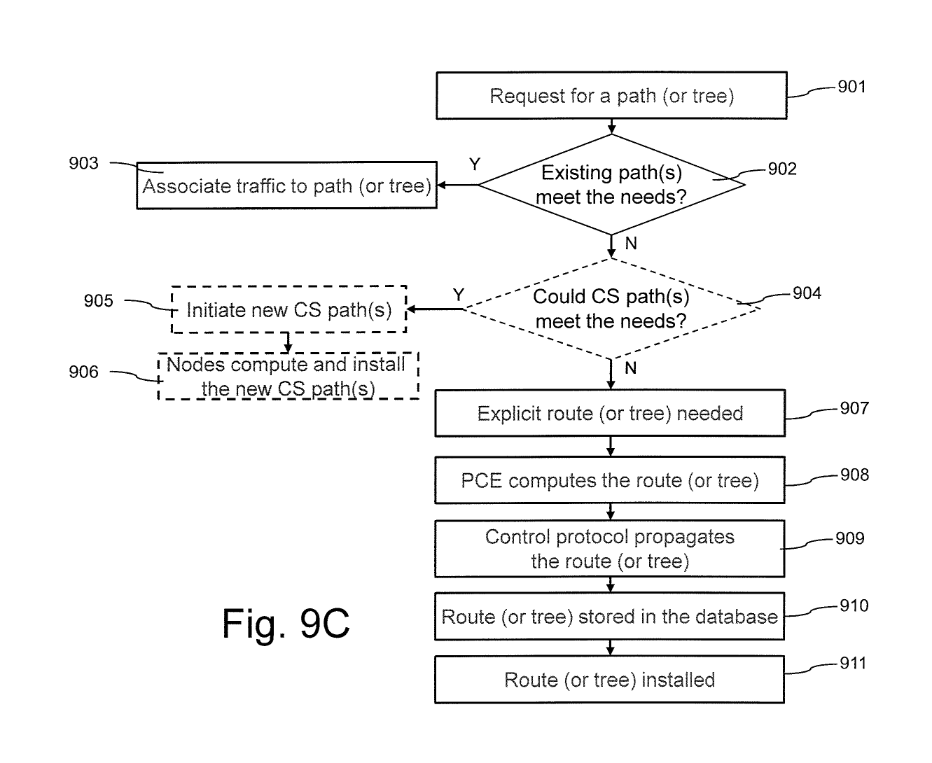

In the following, various embodiments of path control methods will be discussed in more details with reference to the flow diagrams of FIGS. 9A to 9C. The path control methods may be implemented in packet networks as illustrated in FIGS. 3 and 4.

FIG. 9A illustrates a first path control method that may be performed by a combination of an external device and an edge node (e.g., as illustrated in FIG. 3). With reference to FIG. 9A, steps 921 to 923 are performed by the external device, whereas steps 924 and 925 are performed by the edge node coupled to the external device.

In step 921, the external device receives control PDUs from the edge node. The external device may maintain one or more databases from the received PDUs. Then, in step 922, the external device determines an explicit path from the PDUs. The determination in step 922 may be performed in response to an explicit request received from another device or via a user interface of the external device. Once the explicit path has been determined, the edge node is instructed in step 923 to have the explicit path installed. To this end, one or more control PDUs may be sent by the external device to the edge node.

In step 924, the edge node receives the instruction to have an explicit path installed from the external device. As said, the instruction may be received in the form of one or more control PDUs. Then, in step 925, the edge node instructs other network nodes (e.g., other edge nodes and/or core nodes of the network) to install the explicit path. It should be noted that the type of control PDUs sent in step 925 (e.g., the underlying control protocol) can be different from the type of control PDUs received in step 924 (i.e., the underlying control protocol).

FIG. 9B illustrates a further path control method that may be performed by a network node, such as a core node or a edge node. In one variant, the method embodiment illustrated in FIG. 9B may be performed in a network scenario similar to the one illustrated in FIG. 4.

In step 931, the network node receives control PDUs of a control protocol utilized in the network. The control PDUs may be received from other network nodes of the network and may pertain to routing, or forwarding, control. Then, in step 932, the network node determines an explicit path from information contained in the received control PDUs. In step 933, the network node performs an action to make other network nodes install the explicit path (e.g., by sending control PDUs to the other network nodes similar to step 925 in FIG. 9A).

It should be noted that the reception step 931 may be performed concurrently with any of steps 932 and 933. As an example, the reception of control PDUs may continue while steps 932 and 933 are carried out. Similar considerations apply for the reception step 921 in FIG. 9A.

Another embodiment of a path control method is shown in FIG. 9C. It should be noted that the method illustrated in FIG. 9C could be combined with any of the methods illustrated in FIGS. 9A and 9B, or other method aspects discussed herein.

There might be various entities that may request a network path for packet forwarding, for example it can be a host, e.g., host 107 of FIG. 1, attached to a network node, or can be the administrator for the network for the establishment of a new service etc. Furthermore, there might be a need for a tree instead of a (linear) path, e.g., for the distribution of multicast traffic. Therefore, the first step is the request for a path or a tree as shown by step 901 in FIG. 9C. It is then examined in step 902 whether an existing path or tree meets the needs of the traffic that is aimed to be carried on the path.

If yes, then nothing else is to be done but associating the traffic to the appropriate existing path or tree as shown by step 903. If there is no such a path, then one or more Constrained Shortest (CS) paths may be satisfactory. Thus the next step is 904, where it is examined whether new CS paths could make it possible to meet the needs, e.g., traffic requirements. If yes, then the establishment of one or more new CS paths is initiated in step 905 by taking into account the appropriate constraint. As CBR is distributed, the network nodes then compute and install the CS paths on their own in step 906. Note that steps 904, 905, and 906 can only be performed if the network implements CBR, that is why these steps are illustrated by dashed frames.

If CBR is not implemented, then step 907 comes directly after 902. If CBR is implemented but the PCE came to the conclusion in step 904 that CS paths would not provide the paths with the characteristics needed, then an explicit route or explicitly determined tree is needed. In step 908, the PCE then computes the route or tree. If there is no such path in the network that could meet the requirements, then no further steps are made but the PCE reports an error to network management. If the PCE could determine an appropriate path or tree, then the PCE instructs a distributed control protocol applied in the network to propagate the route or tree through the network as shown in step 909.

The instruction may take different forms depending on the architecture applied. If the PCE resides on a network node as shown in FIG. 4 and FIG. 7, then the PCE application just needs to instruct the local instance of the control protocol application. If the PCE is hosted by an external device as shown in FIG. 3 and FIG. 6, then the PCE needs to instruct the network node it is connected to in order to perform the appropriate actions by its control protocol application. The control protocol used for the distribution of the explicit routes may for example be the link state routing protocol applied for controlling the shortest paths, e.g., IS-IS.

In step 910, network nodes then store the route or tree in their local database. Furthermore, the network nodes also install the route or tree in their data plane, thus providing the flow of packets taking the route as shown by step 911.

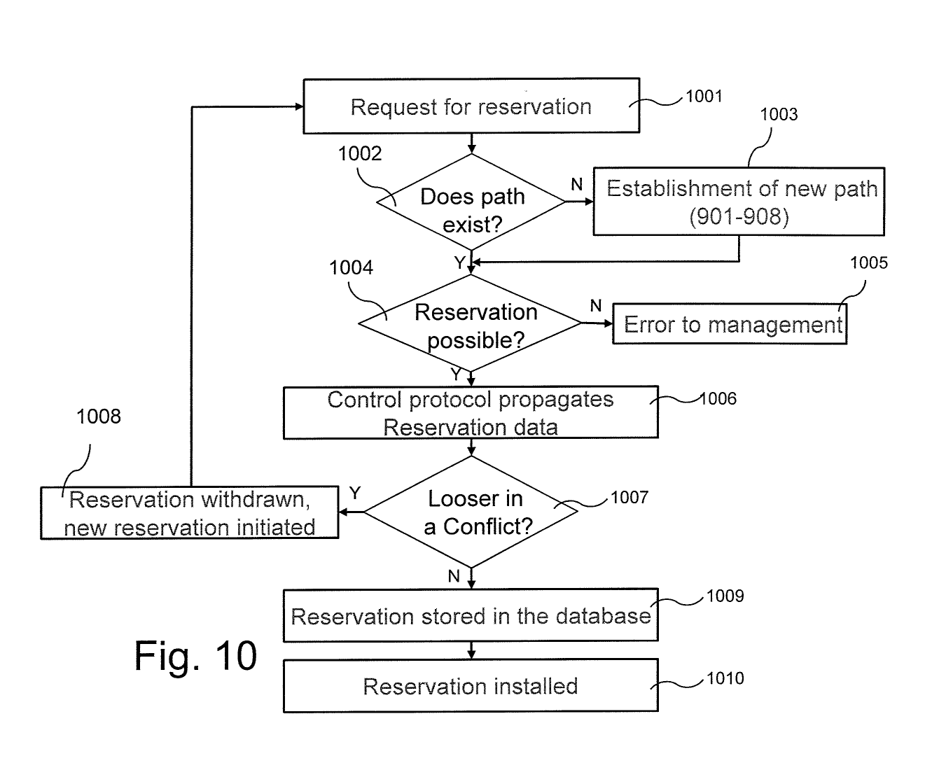

The proposed method in one embodiment also involves a reservation component aside the path control presented above, as there are traffic types requiring the reservation of resources along their path in order to meet their requirements. Reservation may be performed along an existing path, e.g., along a shortest path, or it may happen that a new path is required too aside reservation. An embodiment of a reservation method is shown in FIG. 10.

After having a reservation request in step 1001, the PCE evaluates in step 1002 whether the path for reservation exist. For example, the reservation request may contain an identifier of the path, or reservation just has to be done along the shortest path, which is maintained anyways by the control protocols.

If the path does not exist, then steps 901-908 of the path control method depicted in FIG. 9 are invoked. Note that if there is no such path in the network that could meet the requirements, then no further steps are made after 908, but the PCE reports an error to network management.

If the path was already there in the network, then it has to be examined in step 1004 whether the reservation of required resources is possible along the path. If it is not possible, then an error message is sent to network management in step 1005 and no further steps are taken. Step 1006 is reached if the path is in place in the network and reservation is possible, too. Thus the control protocol applied for invoking the reservation then propagates reservation data in the network, which may for example be the bandwidth required by the given traffic. The control protocol applied for the distribution of this data may be the routing protocol of the network, e.g., IS-IS, or it may be a protocol designed for reservation, e.g., the Multiple Stream Reservation Protocol (MSRP).

It might happen that multiple reservation actions have been initiated in the network for the same resources, which is a race condition for the given resources and causes a reservation conflict. The reservation conflict has to be resolved by an unambiguous tie-breaking, e.g., the reservation will take place for the device having the smallest address (e.g., MAC address) among the devices initiating the reservation. If there is a conflict, then an action has to be taken for the loser as shown by step 1007. That is, the loser is informed on failing in making the reservation, thus it is able to restart the reservation process. Furthermore, the resources reserved during the failed reservation have to be released as shown by step 1008. As step 1009 shows, if the reservation process goes fine, then each network node stores reservation data in their database. Of course, the reservation is also installed as shown by 1010, i.e., network resources are reserved for the given traffic along the path.

As it was mentioned above, the explicit routes and trees, and furthermore, the reservation data, have to be described somehow in order to make their distribution thorough the network. As this data is aimed to be distributed by PDUs of a control protocol, it has to be in the form suitable for these protocols. Note that descriptors of explicit routes are sometimes called Explicit Route Object (ERO) herein.

For the methods described above, the framework of FIG. 5 is proposed for the description of route and reservation data. The descriptor is comprised of Type 501, Length 502 and Value 503 (TLV). There are so many possibilities for the description of the required data, thus a couple of alternatives are only given here on a high level. The Type 501 field may indicate whether it is an explicit route, does it contain reservation, too, or is it only for reservation. Note that explicit routes and explicit trees may have different type fields. The Length 502 field indicates the size of the descriptor object. The Value 503 field is in fact the descriptor data, which may contain subfields or subobjects. For example, the value an explicit route may be a list of node identifiers, e.g., addresses, which list may be sorted. For explicit trees, the description may be based on branching points. Reservation may include attributes of the resources to be reserved or attributes making the local reservation process unambiguous. For example, it can be a bandwidth value. Reservation parameters for an explicit route may be carried in the same ERO.

For the operation of PCR, it might be crucial how the databases applied for the control protocols and for PCR are arranged (see also reference numerals 616 and 706 in FIGS. 6 and 7, respectively). One embodiment proposes the establishment and maintenance of a new type of database, i.e., a database for the explicit routes, which is also referred to as Explicit Route Database (ERDB).

As mentioned above, the most common protocol applied today for the control of forwarding paths within a network domain is link state routing, i.e., IS-IS or OSPF. Having link state routing, databases 801 maintained by network nodes are illustrated in FIG. 8, which databases 801 are maintained by an external PCE, too. That is, the link state protocol maintains the LSDB 802. If traffic engineering extensions are implemented, then the link state protocol also maintains the TED 803. Note that LSDB 802 and TED 803 might be a common database, i.e., a TED 803 may be just an extended LSDB 802. Along the method proposed above, an ERDB 804 is also maintained by the control protocol applied for PCR.

One embodiment proposes to have the ERDB 804 separated from LSDB 802 and TED 803. However, an integrated implementation is also possible. Having a separate ERDB allows that the explicit routes are only stored by the network nodes taking part in the route. Thus, the size of the databases of nodes not participating in the explicit route is not increased unnecessarily, hence processing of the database is not slowed down by unnecessary data. Only the explicit routes are stored in a separate ERDB 804. All reservation data is stored in the TED 803. That is, reservation data for explicit routes, shortest paths and CS paths are integrated, thus the data always shows values relevant for network resources, which is essential for further reservations or constrained routing.

If for example IS-IS is used in the network for shortest path and constrained routing, then the TLV for explicit routes is carried in Link State PDUs (LSP). PCE(s) receive the same LSPs that network nodes, thus PCEs are able to maintain a replica of the LSDB identical to network nodes, which is used as input for path computation by the PCR. After path computation, as described above, the PCE 311, 412, 413 assembles (step 908) the ERO TLV. In case of an external PCE 311, the ERO is sent to the network node 302 the PCE 311 is connected to. The network node 302, 402, 403 then floods an LSP carrying the ERO (step 909), thus the ERO gets to each node of the network. Network nodes along the path (e.g., 306, 406) store (step 910) the ERO in their ERDB (804). Finally, network nodes along the path (e.g., 306, 406) implement the ERO into their forwarding plane (step 911). If reservation has to be performed, too, for the explicit route, then the simplest may be to carry reservation parameters in the same ERO as the explicit route, e.g., a bandwidth value to be reserved on each link. Then, the network nodes along the path (e.g., 306, 406) update (step 1009) their TED 803 according to the reservation parameter, e.g. decrease the available bandwidth on the links involved in the explicit route. The network nodes along the path (e.g., 306, 406) also install (step 1010) the reservation into their data plane.

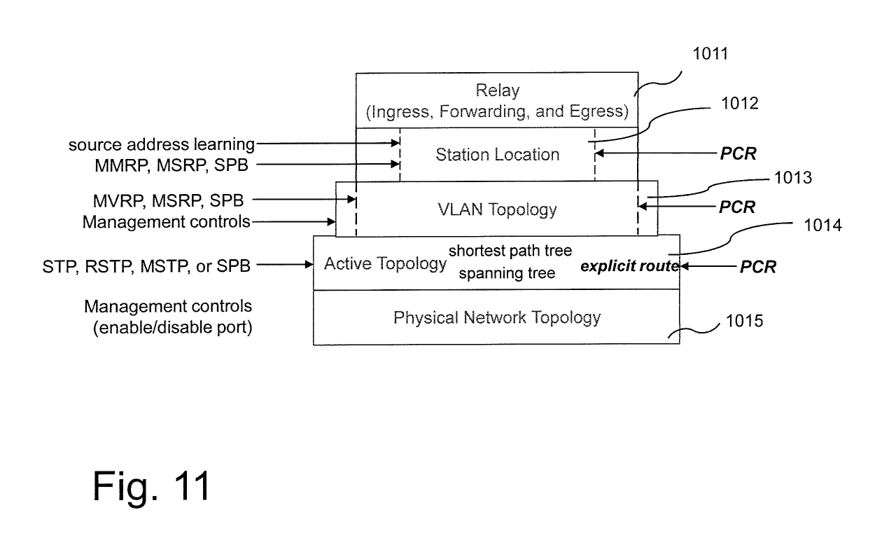

The PCR method proposed herein is for example applicable in Layer 2 (L2) Ethernet networks. The topology structures applied in Ethernet networks are shown in FIG. 11 together with the standard protocols that can control them. Shortest Path Bridging (SPB) is an extension to IS-IS, i.e., applies the IS-IS operation of which principles were described above. The proposed PCR method can be applied with SPB, hence operates as described in the above paragraph. That is, IS-IS is used for the distribution of both path control and reservation data.

MSRP is already used today on top of a spanning tree for stream reservation between Talkers and Listeners in Ethernet networks. Following the principles illustrated in FIG. 11, the control of the Active Topology, i.e., of the forwarding paths, can be replaced from spanning tree to shortest path trees or to explicit routes. MSRP then can run on top, as today. That is, in case of applying MSRP, it may be that only the path control method depicted in FIG. 9 is used, the reservation method of FIG. 10 is not. Note, however, that the databases should be handled as described above for proper operation in that case, too. That is, the reservation data carried in MSRPDUs should be stored in the TED, too.

Having MSRP running in a L2 network, one may prefer to apply MSRP as the control protocol carrier of EROs in step 909. It is not entirely in-line with the layering of FIG. 11, but such an implementation is possible, too. The ERO TLV of FIG. 5 can be carried in MSRPDUs, i.e., today's MSRP can be enhanced to be involved in path control. In such an operation mode, the ERDB is maintained separately as described above based on the EROs received in MRPDUs. That is, such an approach affects only step 909 of the above method embodiment by means of replacing IS-IS with MSRP as the control protocol for ERO distribution. All the other steps of the path control method of FIG. 9 are the same. Reservation then is performed by MSRP operation. Note that despite MSRP has its own reservation process, the integration of the reservation method depicted in FIG. 11 may be valuable, e.g., for conflict resolution, due to having IS-IS controlled paths in the network instead of the former spanning trees.

Interworking between MSRP and IS-IS controlled network domains is possible, too. That is, the PCE(s) may receive MSRPDUs aside the LSPs. For example MSRPDUs are also forwarded to the external PCE 311 in FIG. 3, or the hosts (e.g., 107 and 108) are connected to nodes (e.g., 407 and 403) implementing a PCE application. If each edge node of a network implements the PCE application, then the PCE is able to incorporate reservation data to the EROs, which are then propagated and processed by IS-IS. Thus, MSRPDU exchange can be kept outside of the network domain, i.e. it is kept between hosts and edge nodes (between 107 and 402; between 108 and 403), and the domain is only controlled by IS-IS, e.g. by SPB.

In one or more of the above embodiments, the PCE may be external to the control protocol (e.g., may not take part in the IS-IS or OSPF routing). As such, the PCE application (or daemon) may not be part of the control protocol application (or daemon).

As explained above, the PCE may be hosted in an external device, or end station, which is by definition not part of the control domain (e.g., routing and/or reservation domain). The PCE may thus even become physically external to the network domain. The other option is that the PCE(s) is (are) hosted by network nodes, in which case the PCE application is on the same physical device as the control protocol application, but functionally still remains separated.

As has explained above, the control PDUs need not necessarily be routing or forwarding, protocol PDUs. A functionally interesting alternative are Multiple Registration Protocol (MRP) PDUs, including various MRP applications (MMRP, MVRP, MIRP, MSRP, etc.). As an example, in certain embodiments the PCE may receive all kinds of MRPDUs flooded in the network, and is able to send MRPDUs itself if needed.

As has become apparent from the above, one aspect of the technique presented herein relies on defining Explicit Route Objects (ERO) such that they can describe a path in any network controlled by IS-IS including Ethernet networks. Furthermore, the EROs may be defined such that they may be carried in other PDUs than IS-IS PDUs, (e.g., in MSRPDUs). Additionally, the technique in some embodiments introduces a new database: the Explicit Route Database (ERDB) for the storage of the EROs. It may be that not all network nodes store an ERO, but only the ones along the path determined by the ERO. The method for path control and reservation is specified by some embodiments in a modular structure, thus allowing flexibility for combining different solutions, e.g., the new path control approach with the reservation provided by MSRP in case of Ethernet.

In sum, proposed technique provides an explicit path control and reservation solution that can be integrated into a single protocol, such as IS-IS. Furthermore, the proposed technique is applicable to Ethernet networks, too. Aside being that compact, the proposed technique also provides flexibility by means of its modular structure. That is, it can be used in combination with other protocols providing a piece of the task to be solved. For example, the proposed technique allows different combinations for the use of MSRP and IS-IS together in Ethernet networks.

In the foregoing, principles, embodiments and various modes of implementing the technique disclosed herein have exemplarily been described. The present invention should not be construed as being limited to the particular principles, embodiments and modes discussed herein. Rather, it will be appreciated that various changes and modifications may be made by a person skilled in the art without departing from the scope of the present invention as defined in the claims that follow.

### ABBREVIATIONS

CBR Constrained Based Routing
CS Constrained Shortest
CSPF Constrained Shortest Path First
CN Core Node
EN Edge Nodes
ERO Explicit Route Object
ERDB Explicit Route Database
IGP Interior Gateway Protocol
IS-IS Intermediate System to Intermediate System
LSDB Link State Database
LSP Link State PDUs
MSRP Multiple Stream Reservation Protocol
MSRPDU Multiple Stream Reservation Protocol Data Unit
OSPF Open Shortest Path First
PCR Path Control and Reservation
PDU Protocol Data Unit
RSVP Resource reSerVation Protocol
RSVP-TE RSVP with Traffic Engineering
SPB Shortest Path Bridging
SPF Shortest Path First
TE Traffic Engineering
TED Traffic Engineering Database
TLV Type, Length, Value

1-35. (canceled)

36. A device for explicit path control for traffic forwarding in a network comprising multiple nodes, wherein the device is adapted to be connected to an edge node of the network, the device comprising one or more processing circuits configured as a path computation element, PCE, said PCE configured to:
receive, from the edge node, control protocol data units, PDUs, of a control protocol;
determine an explicit path from information contained in or derived from the received control PDUs; and
instruct the edge node to perform an action to have the explicit path installed in the network.

37. The device of claim 36, wherein the PCE is further configured to maintain a database on the basis of the control PDUs received from the edge node.

38. The device of claim 37, wherein the control PDUs are link state PDUs, LSPs, and wherein the PCE is configured to maintain the database as a replica of a link state database, LSDB, maintained by the nodes in the network.

39. The device of claim 37, wherein the PCE is configured to determine the explicit path from information contained in the database.

40. The device of claim 36, wherein the PCE is configured to instruct the edge node by means of a control PDU initiated by the PCE.

41. The device of claim 40, wherein the PCE is configured to include a descriptor of the explicit path in the control PDU.

42. The device of claim 41, wherein the descriptor comprises type, length, and value, TLV, fields.

43. The device of claim 41, wherein the descriptor further comprises an attribute of a network resource to be reserved.

44. An edge node for explicit path control for traffic forwarding in a network comprising multiple nodes, wherein the edge node is configured to be connected to a device, the edge node being further configured to:
receive, from the device, an instruction to have an explicit path installed in the network; and
send, to the other network nodes, a control protocol data unit, PDU, of a control protocol for instructing the other network nodes to install the explicit path.

45. The edge node of claim 44, wherein the edge node is configured to receive the instruction from the device in a control PDU of the control protocol.

46. The edge node of claim 44, wherein the instruction received from the device includes a descriptor of the explicit path.

47. The edge node of claim 45, wherein the control PDU carries the descriptor of the explicit path.

48. The edge node of claim 46, wherein the descriptor further comprises an attribute of a network resource to be reserved.

49. The edge node of claim 44, wherein the control PDU is one of a link state PDU, LSP, an Open Shortest Path First, OSPF, PDU and a Multiple Stream Reservation Protocol Data Unit, MSRPDU.

50. An node for explicit path control for traffic forwarding in a network comprising multiple nodes, wherein the node is configured to receive control protocol data units, PDUs, of a control protocol, the node comprising one or more processing circuits configured as a path computation element, PCE, said PCE configured to:
determine an explicit path from information contained in or derived from the received control PDUs; and
perform an action to make the other network nodes install the explicit path.

51. The node of claim 50, wherein the node is configured as an edge node of the network.

52. The node of claim 50, wherein the node is configured to maintain a database of the control protocol, wherein the PCE has access to the database for determination of the explicit path.

53. The node of claim 52, wherein the node is configured to maintain the database on the basis of the received control PDUs.

54. The node of claim 53, wherein the control PDUs are link state PDUs, LSPs, and wherein the database is a link state database, LSDB.

55. The node of claim 50, wherein the PCE is configured to perform the action to make the other network nodes install the explicit path include, based on being configured to instruct a local instance of the control protocol application to propagate the explicit path.

56. The node of claim 50, wherein the PCE is configured to instruct an instance of a control protocol application.

57. The node of claim 50, wherein the PCE is configured to determine the explicit path in the form of a list of node identifiers or in the form of branching points of a tree.

58. The node of claim 50, wherein the control protocol comprises at least one of a path control protocol and a reservation protocol.

59. The node of claim 58, wherein the control protocol is one of the Intermediate System to Intermediate System, IS-IS, protocol, an extension thereof, the Open Shortest Path First, OSPF, protocol, an extension thereof, the Multiple Stream Reservation Protocol, MSRP, an enhancement thereof, and a combination of the IS-IS protocol and MSRP or its extensions and enhancements.

60. The node of claim 50, wherein the node is configured to maintain a database that stores explicit paths.

61. A method for explicit path control for traffic forwarding in a network comprising multiple nodes, the method comprising:
receiving, from an edge node of the network, control protocol data units, PDUs, of a control protocol;
determining an explicit path from information contained in or derived from the received control PDUs; and
instructing the edge node to perform an action to have the explicit path installed in the network.

62. A method for explicit path control for traffic forwarding in a network comprising multiple nodes, the method comprising the following steps performed by a node of the network:
receiving an instruction to have an explicit path installed in the network; and
sending, to the other network nodes, a control protocol data unit, PDU, of a control protocol for instructing the other network nodes to install the explicit path.

63. A method for explicit path control for traffic forwarding in a network comprising multiple nodes, the method comprising the following steps performed by a node of the network:
receiving control protocol data units, PDUs, of a control protocol;
determining an explicit path from information contained in or derived from the received control PDUs; and
performing an action to make the other network nodes install the explicit path.

64. The method of claim 63, further comprising maintaining a database that stores explicit paths.

65. The method of claim 64, further comprising maintaining the database separately from at least one of a link state database and a traffic engineering database.

66. The method of claim 64, wherein the explicit paths stored in the database are only stored by network nodes that take part in those paths.

67. The method of claim 63, wherein determining an explicit path comprises selectively calculating the explicit path in case no existing path meets prevailing needs.
